(19) United States
(12) Patent Application Publication
(10) Pub. No.: US 2005/0075966 A1
(43) Pub. Date: Apr. 7, 2005

(54) Method of processing, displaying and trading financial instruments and an electronic trading system therefor

(76) Inventor: Andrey Duka, Genthod (CH)

Correspondence Address: BAKER & DANIELS, 205 W. JEFFERSON BOULEVARD, SUITE 250, SOUTH BEND, IN, 46601, US

(21) Appl. No.: 10/503,147

(22) PCT Filed: Jan. 29, 2002
(86) PCT No.: PCT/IB02/00326

(51) Int. Cl. G06F 17/60

(52) U.S. Cl. 705/37; 705/35

(57) ABSTRACT

An electronic trading system is described, where a client site may access data through a communications network, such as the internet, from data bases, both internal and external. The trading system allows the user to access the data and display various graphical elements on a PC screen. Such graphical elements may include a graphical representation of a financial instrument, and a graphical representation of a financial information analysis tool for the given financial instrument. The system software also provides the user with the ability to apply at least one condition on the first graphical element, relative to the second graphical element, such that an action is automatically taken when the condition is satisfied.

The present invention relates to an electronic trading system for processing and graphical representation of financial information for assisting a trader or investor in executing trades of financial instruments, such as currencies, stocks, derivatives, bonds, etc.

The analysis of financial instruments based on historical information is a specialist field of activity called “Technical Analysis”. An objective of performing technical analysis is to assist the trader or investor in deciding whether and when to buy or sell financial instruments, for example currencies, shares, derivatives, bonds, or other values traded on financial exchanges.

Conventional technical analysis is typically performed by an analyst studying charts of historical parameter changes presented on a computer screen. The financial parameter is selected over certain time frames, such as hourly, daily, weekly or monthly, and the technical analyst uses certain tools to assist in analysing the information, for example he may draw “support” and “resistance” lines through low and high peaks, respectively. If the analyst considers that the lines drawn are representative of the market trend, a drop in value of the financial instrument below the support line would for example indicate a strong downward signal (leading to a “sell” recommendation) or conversely, if the value of the financial instrument exceeds the resistance line, then this is an upward signal (leading to a “buy” recommendation). A technical analyst will probably look simultaneously at different time frames to distinguish between longer and shorter term trends. Knowledge of “market psychology” and the company or field to which the financial parameter relates will also influence the analyst's reception of the information he is analysing. The conventional analyst thus primarily bases his forecast on intuition and experience, the information analysis tools at his disposition being graphical aids of a very simple nature.

In international patent application WO 01/95176, a method of processing financial data for graphical representation and analysis thereof in order to assist a trader or investor in forecasting the trend of a financial instrument, is described. In the aforementioned application, the real-time graphical representation of a financial parameter is transformed into a line of discrete increments to produce a curve in “Increment Change Space” on which information analysis tools, such as support and resistance lines, trend development equation curves, quantum lines, and other graphical elements may be superposed. A better understanding of the transformation and generation of these information analysis lines may be obtained from the aforementioned patent application, which is incorporated herein by reference thereto. These information analysis tools are particularly helpful in assisting a technical analyst, a trader, an investor, or other market participant (hereinafter referred to as “market participant”) in analysing the trend of a financial instrument in view of forecasting its development and ultimately issuing a trading recommendation or executing a trading decision based on such forecast.

Considering the desire or need of many market participants to analyse and act on changes in financial information rapidly, it is therefore an object of this invention to provide a method for processing and displaying information on a financial instrument that enables a market participant to rapidly and easily analyse such information and take action with respect thereto with simple and rapid operations. In particular, it is advantageous to provide a method of analysing and displaying information on a financial instrument that enables trading of such instrument by a market participant with few and simple operations.

It is a further objective of this invention to provide an electronic trading system that enables a market participant to analyse historical information on a financial instrument with the aid of information analysis tools, such as support and resistance lines, and take action such as executing a trade in a simple and rapid manner.

It is advantageous to provide a method for processing and displaying financial information and a trading system therefor that enables a market participant to make a trading decision based on a plurality of different information analysis tools, such as support and resistance lines, development curves, quantum lines, and beam average curves, on the basis of a visual interpretation of the financial information and information analysis tools.

It is advantageous to provide a method for processing and displaying financial information and an electronic trading system therefor, that allows a market participant to work on a plurality of financial instruments.

It is an advantage to provide an electronic trading system that enables the market participant to place automatic trading orders based on certain conditions that may be created and edited prior to validating the automatic order.

Objects of this invention have been achieved by providing a method of processing and displaying financial information according to claim 1.

Disclosed herein is a method of processing and displaying financial information on an electronic display, such as a computer screen, comprising the steps of: selecting a financial instrument; displaying on the display a graphical representation of the financial instrument; generating and displaying on the display a graphical representation of an information analysis tool; selecting the graphical representation of the financial instrument and the graphical representation of said information analysis tool by means of a cursor graphically represented on the display and movable by a controller device, such as a mouse operated by a market participant; and applying a comparative condition on said graphical representations enabling action to be taken on said financial instrument depending on the future movement thereof.

Objects of this invention have also been achieved by providing an electronic trading system according to claim 12.

Disclosed herein is an electronic trading system for assisting a market participant in trading in a financial instrument, comprising a server system for processing data on a financial instrument and software for generating and displaying an image including graphical elements on an electronic display, a first graphical element being a graphical representation of a financial instrument and a second graphical element being a graphical representation of a financial information analysis tool, said software adapted to enable selection of said first and second graphical elements by means of a display pointing device and to enable applying at least one of a plurality of conditions on said first graphical element with respect to said second graphical element such that an action is taken automatically by said server system on said financial instrument when said condition is satisfied.

The information analysis tools that may be graphically represented on the electronic display may be support and resistance lines, development curves, quantum lines, beam average curves and other information analysis tools as set forth in international application WO 01/195176. The financial instrument may be graphically represented as a real curve, i.e. a two-dimensional chart of the value of the financial instrument as a function of time or date as commonly represented on screen of conventional electronic trading systems, or as a broken line representing the financial parameter in Increment-Change space as set forth in WO 01/95176.

Advantageously, the invention thus enables a market participant to rapidly set conditions for an automatic trade or trade recommendation on a financial instrument by selecting with a display pointing device, such as a mouse controlling a screen cursor, graphical representations of the financial instrument and of the chosen information analysis tool.

One or more information analysis tools may be generated and displayed on the electronic display. Multiple conditions may be applied for acting on the financial instrument. Different conditions may be available to the market participant including a condition “greater than” and a condition “less than” which, when applied to the graphical representation of the financial instrument and an information analysis tool, enable for example opening or closing a position on the financial instrument when the condition is fulfilled. In the latter examples, the conditions are fulfilled when the curve representing the financial instrument crosses the curve representing the information analysis tool. By way of example to illustrate what is meant if the comparative condition applied is “less than” and the information analysis tool is a support line, when the graph of the financial instrument crosses the support line downwards, the trading system either executes a trade or informs the market participant that the condition has been fulfilled. In this case, the action recommended to the market participant may be to sell the financial instrument if he considers that the crossing of the support line by the graph of the financial instrument indicates that a significant support level has been broken.

The information analysis tools may also include simple values at which the trade should be executed, for example a fixed price at which a financial instrument should be bought or sold, and other values commonly used by traders such as stop-loss values.

Advantageously, the financial data used to generate the graphical representation of the financial instrument may be obtained in real-time from an internal (own) data source or through a global telecommunications network such as the Internet, from a database supplied by an external financial information service provider, or an electronic financial exchange.

The electronic trading system may advantageously generate an image on the display, comprising a trading window with fields that may be selected by means of an electronic controller device such as a cursor or a keyboard for generating and sending a quote or order for a trade to be executed automatically at a remote electronic financial exchange or through an electronic system.

Further objects and advantageous aspects of this invention will be apparent from the claims and the following description, with reference to the drawings in which:

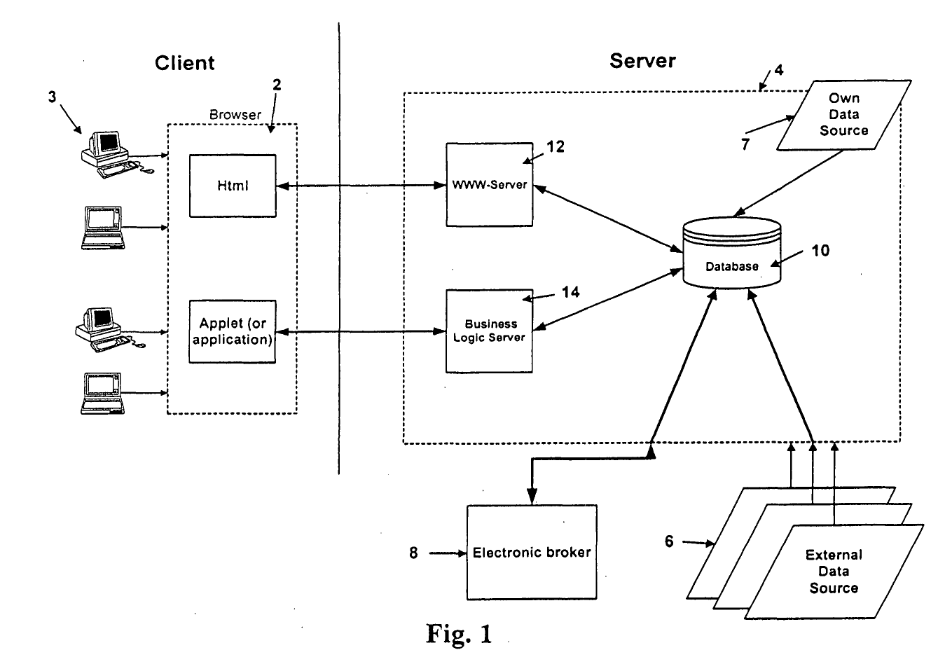

FIG. 1 is a simplified block diagram illustrating the overall structure of an electronic trading system according to this invention;

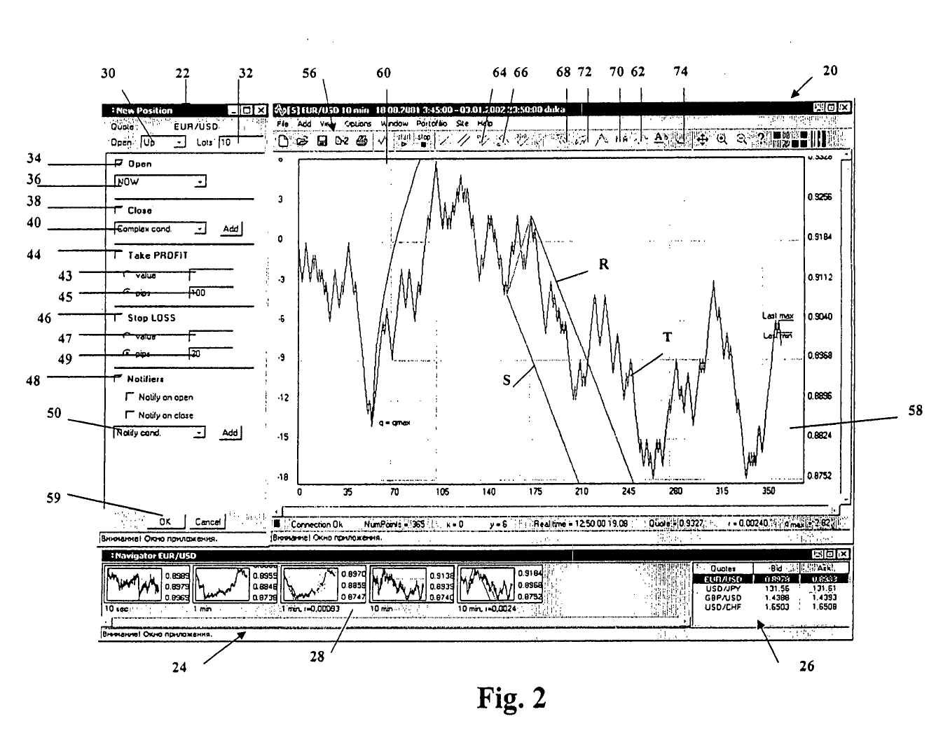

FIG. 2 is a view of an image on an electronic display according to this invention;

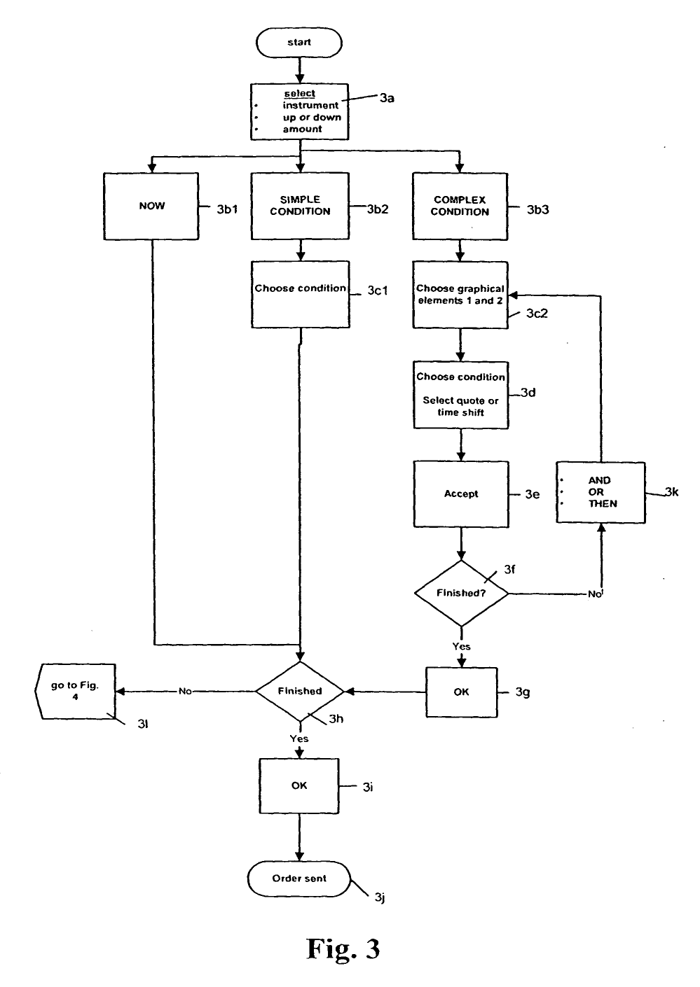

FIG. 3 is a flow-diagram of a routine to create an order for a trade, in this particular case for opening a new position with an electronic trading system according to this invention;

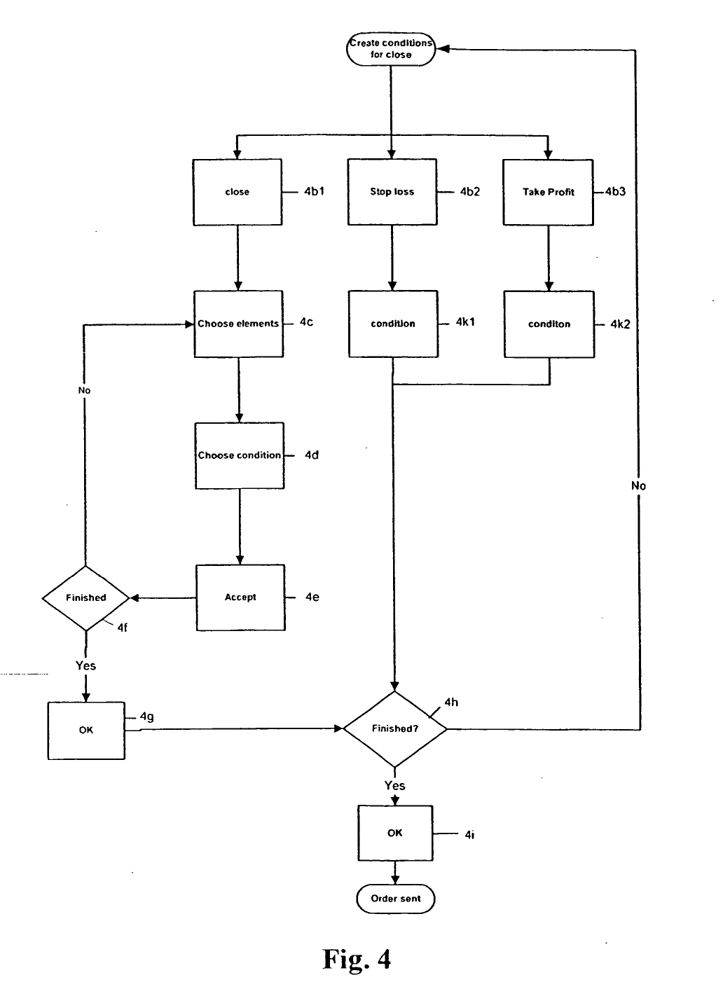

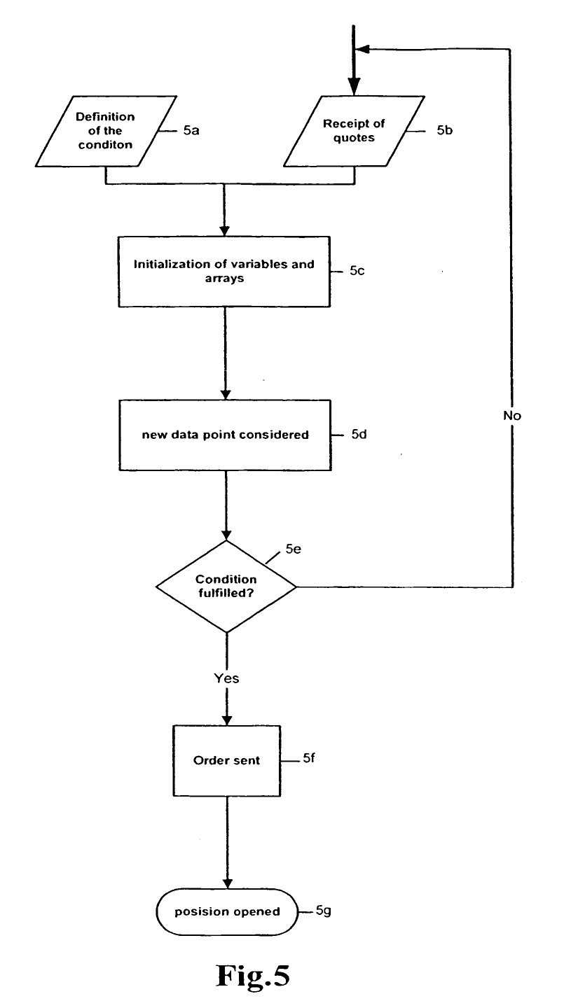

FIG. 4 is a flow-diagram of a routine to generate an order for a trade, in this case for closing a position with an electronic trading system according to this invention;

FIG. 5 is a flow-diagram of a routine for sending an order to open a market position in accordance with a condition created by a market participant in an electronic trading system according to this invention;

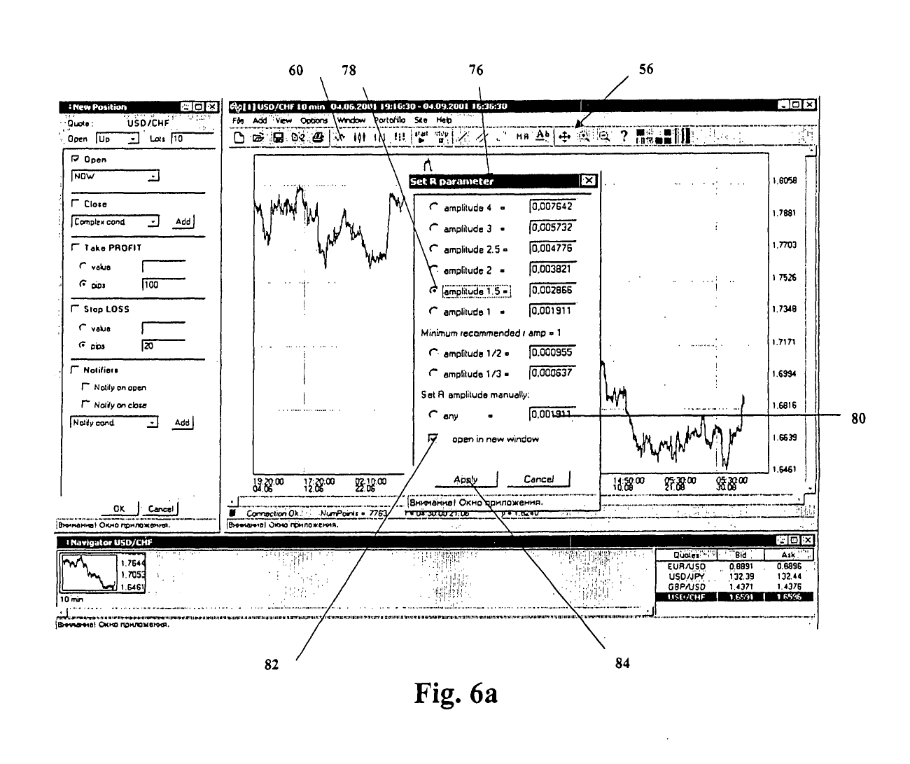

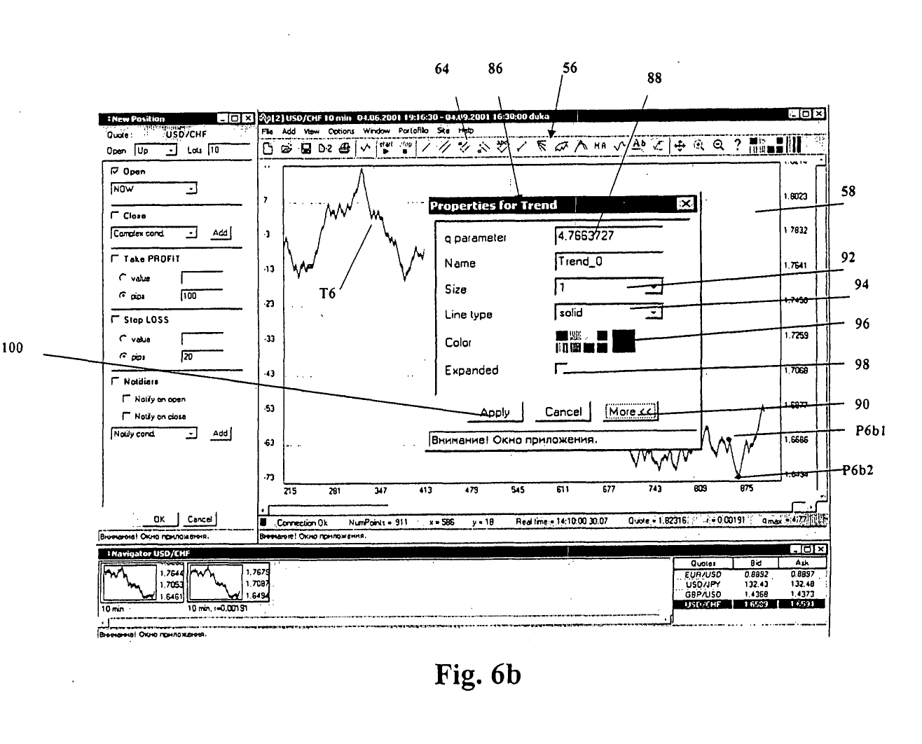

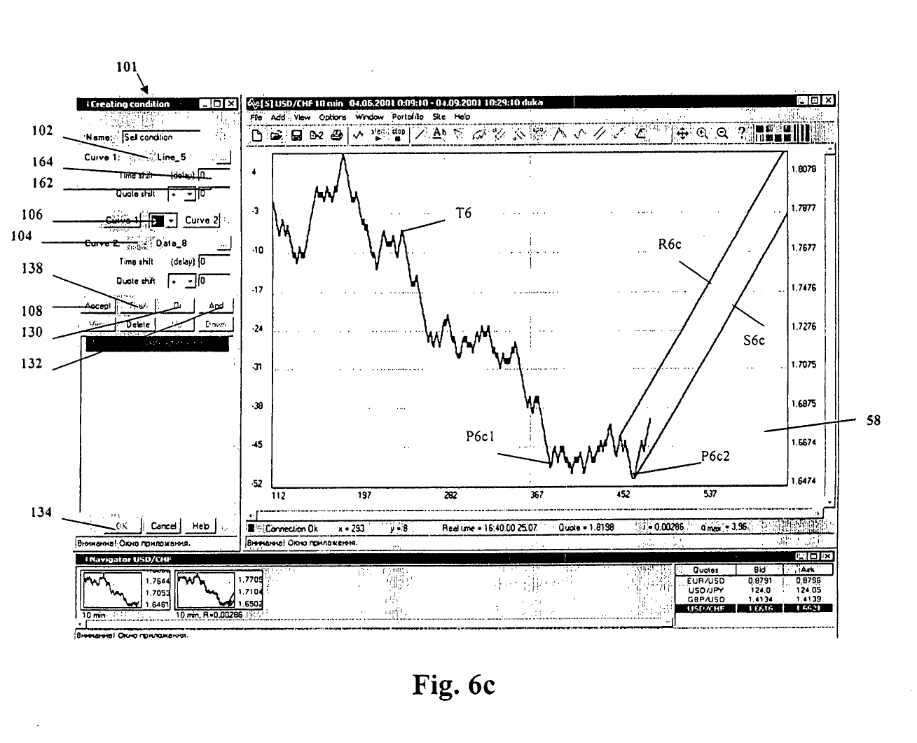

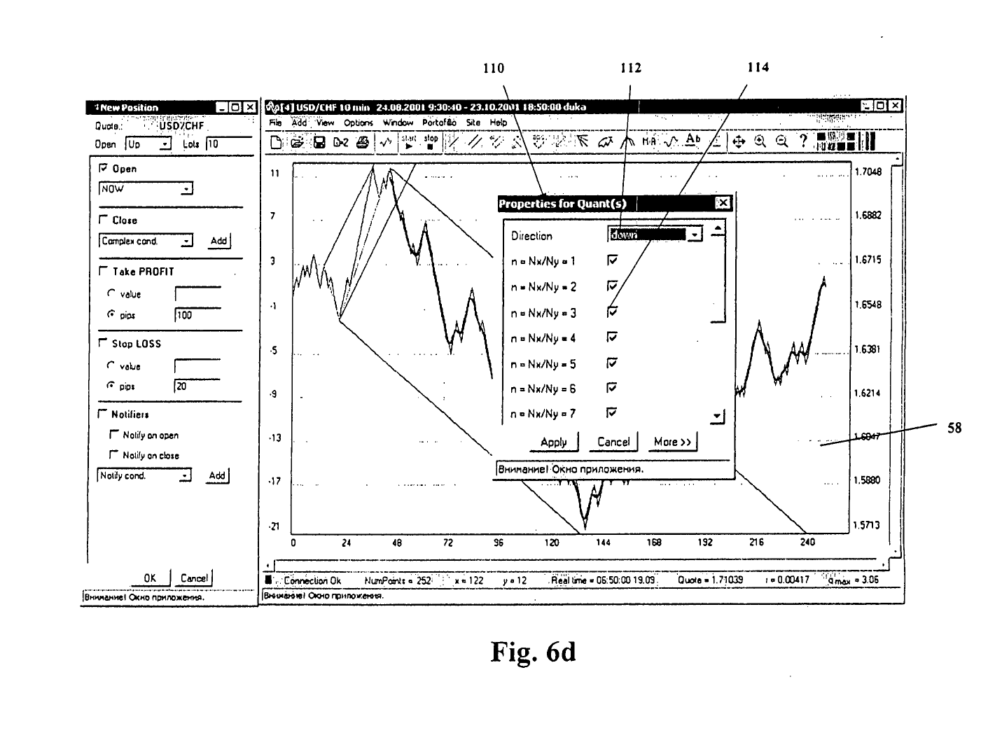

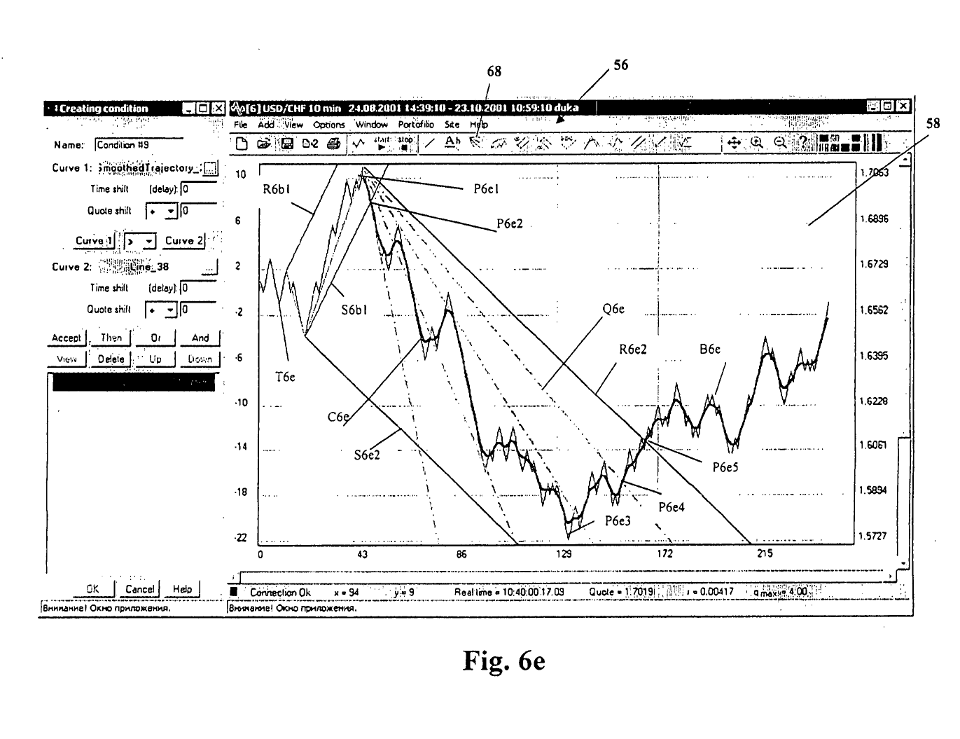

FIGS. 6a to 6e is a series of images of a display according to this invention with a window illustrating a chart of US Dollar/Swiss Franc exchange rate quoted every ten minutes for the period Jun. 4, 2001 to Sep. 4, 2001, FIG. 6a showing the real curve and FIGS. 6b to 6e the trajectory in Increment-Change space and the different windows for the generation and superposition of a plurality of information analysis tools;

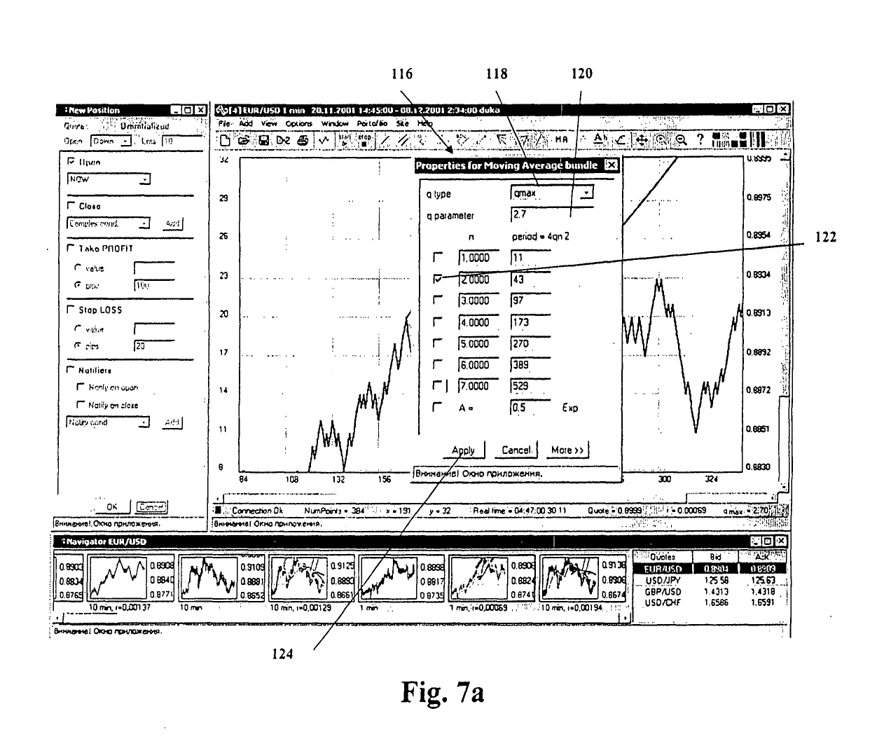

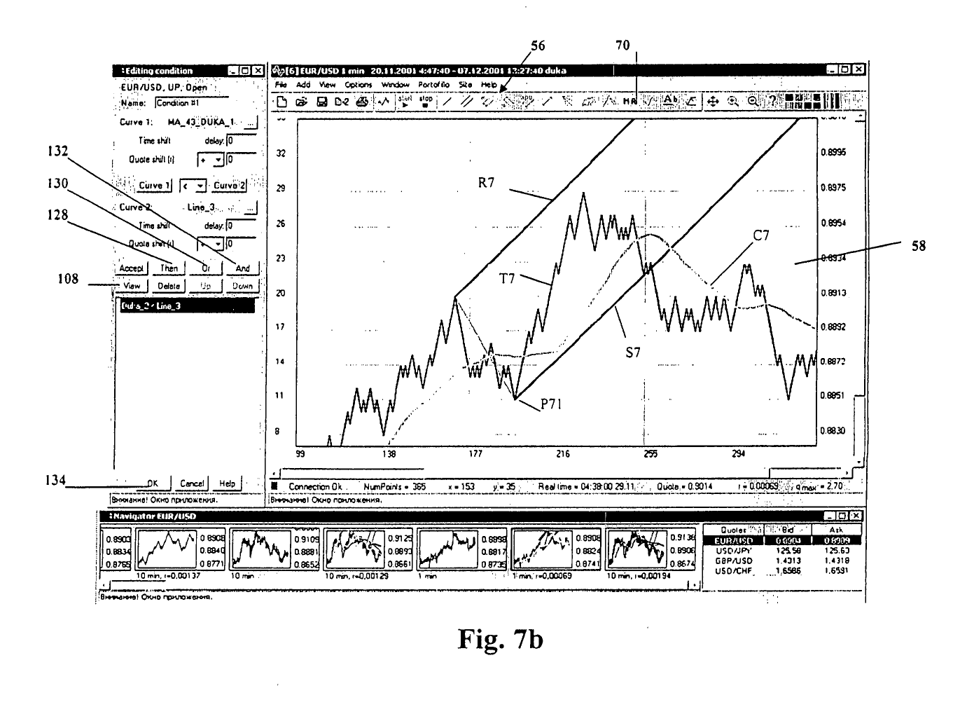

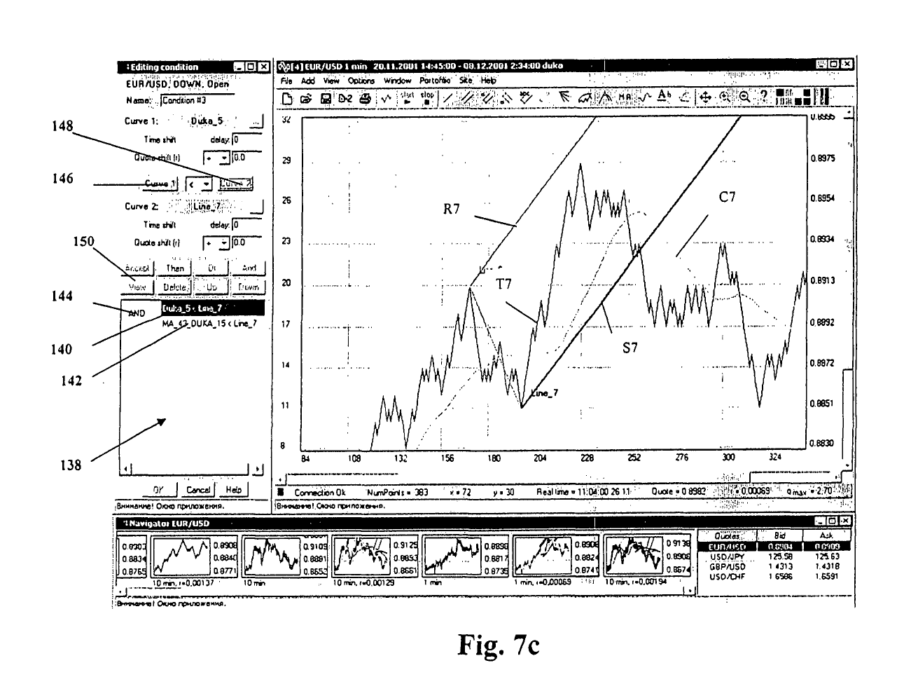

FIGS. 7a to 7c are a series of images of a display according to this invention, showing different windows for displaying financial information, selecting conditions, selecting financial instruments and setting display and analysis parameters;

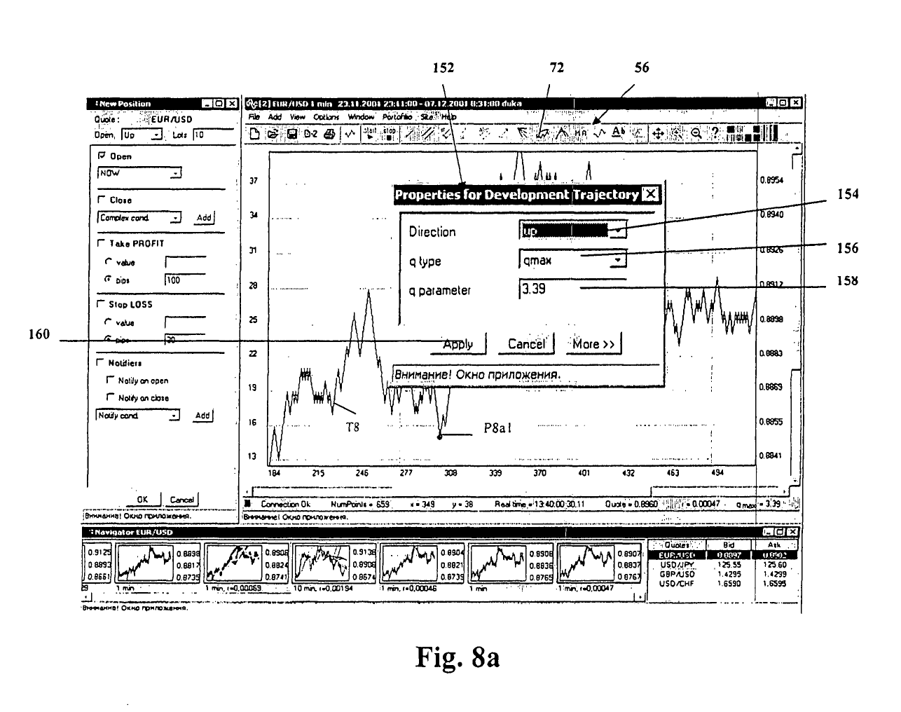

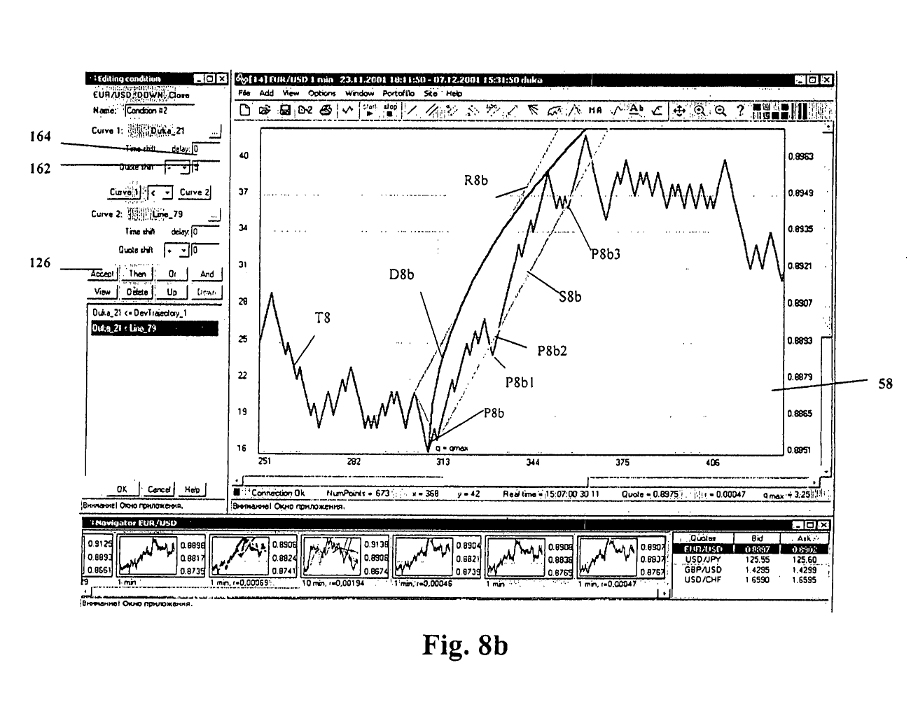

FIGS. 8a to 8b are images of a display with windows similar to those described in relation to FIG. 7, but displaying different financial information and different information analysis tools; and

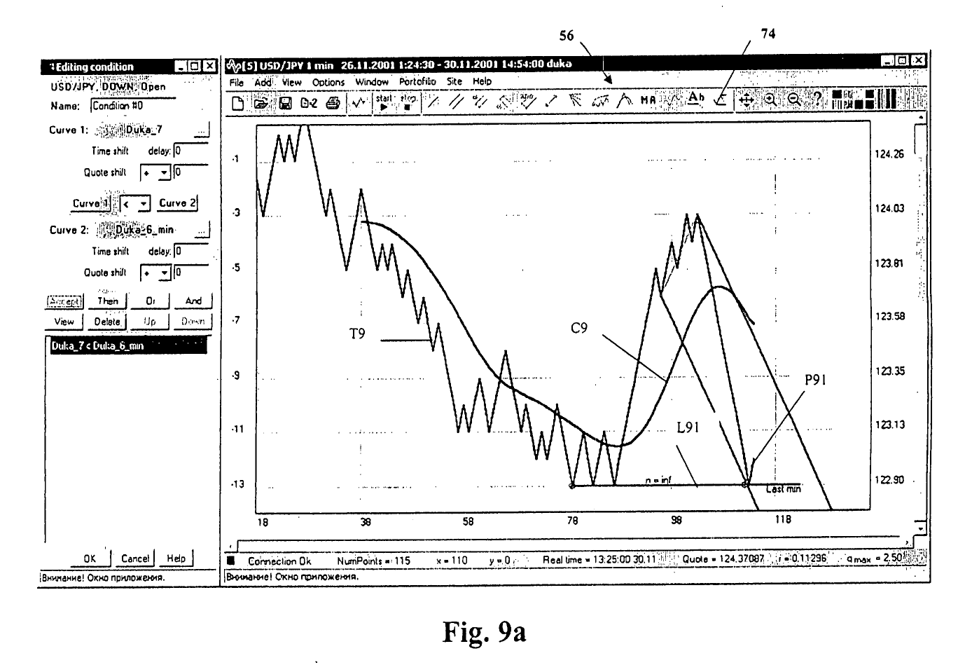

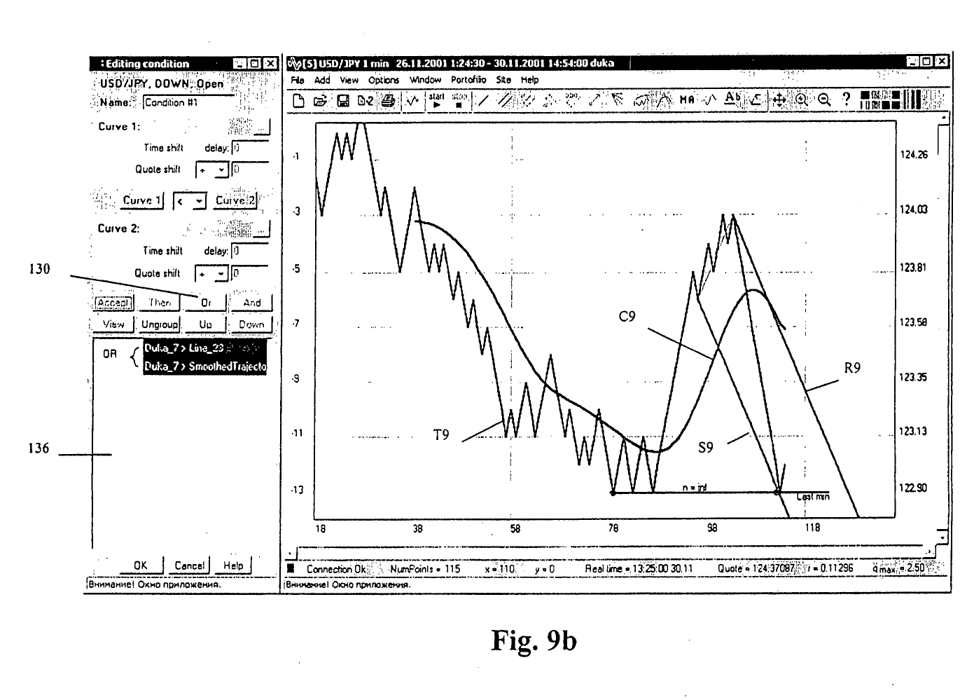

FIGS. 9a and 9b are further images of a display with windows similar to those described in relation to FIG. 7, but displaying different financial information and information analysis tools.

Referring to FIG. 1, a trading system is shown that enables online technical analysis and trading over a telecommunications network, for example over the internet using the world-wide web. In the embodiment shown, the trading system comprises a client site 2, representing one or more market participants having for example personal computers 3 connected to the telecommunications network, a server site 4, an external data source 6, an internal data source 7 and a broker 8. The broker may be a physical person with a terminal or PC, or an electronic broker such as found on an electronic financial exchange (hereinafter generally referred to as “broker”). The server site 4 is connected to the telecommunications network and may be accessed by authorized market participants 3. The broker 8 may also be connected to the server site by means of a telecommunications network such as internet, or other networks, but may also be connected to the client site 2 for receiving trading orders directly from market participants 3. Real time or delayed financial data to the server site 4 may be provided by an external data source 6 which may be a financial information service provider or a financial exchange connected via a telecommunications network to the server site or by an internal (own) data source 7.

The server site 4 comprises a server system including a database server 10, a communications server 12, such as a world-wide web server, and a business server 14, such as a Business Logic Server. The database 10, the communications server 12 and the business server 14 may be integrally included in a single data processing system, or form a distributed data processing system with servers at different locations communicating via a telecommunications network. The database server system 10 is connected to the data sources 6 and 7 which provide regularly updated or real-time data on financial instruments from one or more different information service providers.

The data base server may further perform the functions of storing the trading orders received from market participants, maintain a history of trading operations, and manage operations on market participant accounts. The database server system 10 is connected to the business server 14 and communications server 12 to enable for example the market participants to communicate with the server site via a browser 16 of the client site, using for example an HTML protocol. Using the network connection established between the Client site 2 and communications server 12, the market participant may download an applet or an application from the business server 14 in order to enable the participant to send requests for information and orders to the server site and to receive requested data or information, or to perform required operations. For example, in order for a market participant to obtain a graphical representation of real market data on his PC screen, the market participant, via his terminal PC and browser, sends a request to the business server 14 which processes the request and retrieves the relevant data from the database server 10. The server site sends a response to the client site and the market participant's PC reproduces the response in the form of graphical elements plotted on his PC computer screen to form an image as illustrated for example in FIG. 2. The various windows that are created on the electronic display, in this example the market participant's PC or terminal computer screen, may be generated by software downloaded from the business server, or pre-installed in the market participant's computer. In summary, the main operations performed by the server site 4 include: data acquisition and handling, generation and processing of data (for example to perform Increment-Change space transformations of real space financial data and the generation of information analysis tools which require a lot of computing resources); data storage; reception, processing, and transmission of market participants' trading orders and requests; maintenance of a logbook of operations; generation and storage of statistical data; and management of market participant accounts.

It may also be noted that the processing of data may be also run on the user computer by downloading the processing software from the central server, or by software already installed on the user computer. The storage and processing of market data can be organised with different degrees of centralization or decentralization of database storage and information processing systems without parting from the scope of this invention.

Referring to FIG. 2, an image generated by an electronic trading system according to this invention is shown, comprising a charting window 20, a trading position input window 22, a navigation window 24, and a quote window 26.

The quote window 26 displays various financial instruments, for example currency quotes for the selection of currencies chosen by the market participant, indicating in real time the present value of the financial instrument, for example the “bid” and “ask” price of a currency in relation to another currency. Other information may be provided in the quote window 26 depending on the type of financial instrument, for example in the case of stocks, the quote window may display the identity of the stock, the present price, the high and low prices of the day or of other periods chosen by the market participant, the closing prices from the previous day and the trading volume. Other information may be provided, in particular values related to a financial instrument that are typical of the information provided on a financial exchange.

In the navigator window 24, a series of charts that have been created and opened by the market participants are displayed, for example in the form of small charts 28 that may be selected like screen icons with a display pointing means. The display pointing means could include a screen cursor controlled by a controller device, such as a PC mouse, track ball, touch pad, joystick, or other pointing device controller. The pointing device may also be a touch-sensitive screen responding to the touch of a person's finger or a pointing pen touching the display at the position of the chart icons 28. For simplicity, the aforementioned pointing means and corresponding controller devices will be generally called hereinafter “cursor” and it will be understood that the cursor or a key-board may be used to select icons and graphical elements displayed on the electronic display.

It may be noted that the charts displayed in the navigator window relate to the same financial instrument selected in the quote window 26, but with different information analysis tools generated thereon, different Increment-Change space transformations or real space representations, different time periods, or combinations of the aforementioned. The charts may also represent different financial instruments, which may be useful if the market participant believes that the information on a certain financial instrument is correlated or influenced by changes in another financial instrument, for example the correlation between the price of crude oil and the price of stocks in an oil company.

The input window 22 enables the market participant to create a trade order, in particular to define whether a new trade should be opened or an existing trade should be closed, the volume (i.e. the value) of the trade, and the conditions for executing the trade. Various parameter entry fields are provided in the input window for this purpose. These include an “Up-Down” field 30 to define whether the market participant wishes to trade up or down. For example, if the financial instrument is a futures contract, a market participant trading up would be expecting the financial instrument to increase in value and therefore buy long, whereas trading down would mean that the market participant expects the financial instrument to decrease in value and therefore sell short.

A “lots” field 32 enables the market participant to define the number of lots or units of a certain value of the financial instrument to be selected, in other words to define the value (volume) of the trade. For example, a market participant may select ten lots of the financial instrument EUR/USD, whereby one lot would for example represent the trade in Euros of USD10,000.

An “open” checkbox 34 enables the market participant to define whether a new position is to be opened.

An “open condition” field 36 enables the market participant to determine how the trade should be ordered or executed, for example at market, meaning at the market price prevailing at the time the request is sent, at a simple condition, meaning at any other price that may prevail in the future or at a complex condition, meaning that conditions are applied to pairs of graphical elements that are selected by the market participant with the cursor or keyboard in the charting window 20.

A “close” checkbox 38 enables the market participant to request an existing trade to be closed automatically upon the fulfilment of a certain condition.

A “close condition” field 40 enables the market participant to select the type of condition to be applied to the financial instrument for executing the closure of a market position, whereby the conditions are applied to pairs of graphical elements that are selected by the market participant with the cursor or keyboard in the charting window 20.

A “take profit” checkbox 44 enables the market participant to define the potential profit value in take profit entry fields 45, 47, at which a trade should be closed in the event the financial instrument moves in the favourable direction for the market participant.

A “stop loss” checkbox 46 enables the market participant to define stop-loss values, in stop-loss entry fields 47, 49 for closing a trade to limit a potential loss in the event the financial instrument moves in the adverse direction for the market participant.

A “notifier” checkbox 48 and related “notify condition” fields 50 enable the market participant to define whether he wishes to be notified, for example by means of an alarm or notification signal appearing on the display, of the occurrence of an event, for example when the conditions previously specified are attained.

The charting window 20 comprises a bar 56 with a series of commands in the form of icons that may be selected with the cursor for creating, processing, editing and displaying graphical elements in a chart area 58, the graphical elements including a graphical representation T of the financial instrument, which may be a representation in real space or in Increment-Change space, and information analysis tools that are generated and superposed on the chart, for example support S and resistance R lines. A method of generating such lines is described in international patent application WO 01/95176. Each of the lines or curves generated and represented in the chart area 58 will for simplicity hereinafter be generally called “graphical elements”.

Referring to FIG. 3 in conjunction with FIGS. 2 and 6a to 6e, a flow diagram of a routine to create an order for opening a new position in the electronic trading system, will now be described.

In step 3a the market participant selects in the “Up-Down” field 30 the type of market position to be opened, i.e. up or down, and in the quote field 26 the type of instrument to be transacted, which could be a currency, a stock, a future etc. and in the lots field 32 the volume of the transaction. In the next step 3b, the market participant may select in the choose condition field 40 one of three choices for the opening procedure: “now”, on a “simple condition” and on a “complex condition”.

A “now” request (step 3b1) means carrying out a transaction at market prices prevailing at the moment the order is issued, i.e. at the next available bid quote for a down transaction and ask quote for an up transaction. If the market participant has finished setting conditions for opening the order he proceeds to step 3h and terminates (step 3i) by clicking on the OK button 59. The algorithm is then terminated and the order request is automatically sent to the business server 14. If the market participant intends to create some additional conditions on which fulfilment the position will be automatically closed he proceeds with the routine shown in FIG. 4.

A “simple condition” request (step 3b2) means creating a condition for opening a position at a concrete market quote. More specifically, the market participant can select to open a position if the quote reaches a value specified by the market participant in a simple condition field. If the market participant has finished setting conditions, he proceeds to step 3h, and terminates (step 3i) by clicking on the OK button 59. The algorithm is then terminated and the order request is automatically sent to the server. If the market participant intends to create some additional conditions on which fulfilment the position will be automatically closed he proceeds with the steps shown in FIG. 4.

Selecting “complex condition” in field 40 opens a complex condition sub-window 101 (see FIG. 6c). A “complex condition” request means creating a condition for opening a position using graphical elements displayed in the chart area 48. The selection “complex condition” in the fields 36 or 40 opens a complex condition sub-window 101 (as shown for example in FIG. 6c) setting and applying the complex condition. In step 3c2 using the cursor the market participant selects two graphical elements displayed in the chart area 58. In step 3d the market participant selects the type of condition at which the order will be executed. The available conditions include in particular comparative conditions “>”, “≧”, “<”, “≦”, whereby the vertical axis value of one graphical element is respectively “greater than”, “greater than or equal”, “smaller than”, “smaller than or equal” to that of a second graphical element. The term “graphical element” includes the Increment-Change space trajectory, trend support and resistance lines, any line drawn in Increment change space, quantum lines, last minimum-maximum lines, development equation curves, beam trajectories, or any other graphical element available to the market participant and displayed in the charting window. The market participant can also specify a quote shift delay measured in basis points, in a quote shift field 162 (see FIG. 6c), such that the order will be implemented upon the achievement of the previously described condition plus or minus the value of the quote shift. The market participant can specify a time shift measured in standard units of measurement of the horizontal axis in the Increment Change Space, in a time shift field 164, such that the order will be implemented upon the fulfilment of the condition described above plus the value of the time shift. In step 3e, the market participant may validate the complex condition by clicking on the “Accept” button 108 (see FIG. 6c).

Once the market participant is finished (step 3f), he validates the complex condition by clicking on the OK button 59 (step 3g). Otherwise, the market participant proceeds to step 3k and chooses an operator for the interaction of two or more graphical conditions created according to the procedure in steps 3c2 to 3f by selecting one of the buttons “then” 128, “or” 130, or “and” 132 in the input window. The “and” operator implies that both conditions need to be fulfilled. The “then” operator implies that the conditions need to be fulfilled in a particular order, i.e. one after the other. The “or” operator means that one of the two conditions must be fulfilled. The market participant then returns to step 3c2 and repeats steps 3c2 to 3f for the same or another pair of graphical elements. Once the selection is finished the market participant proceeds to step 3g and validates the complex condition by clicking on the OK button 134 in the complex condition sub-window. Once the market participant has finished setting conditions for open order he proceeds to step 3h, and terminates the request by clicking on the OK button 59 in the input window. The algorithm is then terminated and the order request is automatically sent to the server system. If the market participant intends to create some additional conditions on which fulfilment the position will be automatically closed he proceeds with the steps shown in FIG. 4.

FIG. 4 is a flow diagram of a routine that sets up additional conditions to close a position automatically. This can be done by choosing any or all of the following “close” 4b1, “stop-loss” 4b2 and “take profit” 4b3.

To create the “close” request, the market participant follows a routine 4c, 4d, 4e, 4f replicating the one described in steps 3c2 to 3e in FIG. 3. Once the market participant has finished setting conditions for opening an order he proceeds to step 4i, and terminates the request by clicking on the OK button. The algorithm is then terminated and the order request is automatically sent to the server. If the market participant intends to create some further conditions to close a position, he returns to the start of the algorithm.

A “stop loss” request 4k1 means creating a condition such that in case of adverse movement, the position is closed when a certain quote is reached, the value of which is either indicated specifically by the market participant or at a value of the opening price, minus (for an up position) or plus (for a down position) a number of the basis points specified by the market participant. By setting the stop loss condition the market participant defines the exposure and the maximum amount of loss he is willing to take on this position. If the market participant has finished creating the additional conditions he proceeds to step 4h, and terminates by clicking on the OK button. The algorithm is then terminated and the order request is automatically sent to the server system.

A “take profit” request 4k2 means creating a condition such that in case of a favourable movement of the market the position is closed when a certain quote is reached, the value of which is either indicated specifically by the market participant or at a value of the opening price, plus (for an up position) or minus (for a down position) a number of the basis points which is specified by the market participant. Once the market participant has finished creating the additional conditions he proceeds to step 4h, and terminates by clicking on the OK button. The algorithm is then terminated and the order request is automatically sent to the server system.

In case the market participant sets up several conditions for closing a position the system executes the first one to be fulfilled upon the receipt of new market data.

FIG. 5 is a flow chart describing the process of opening a market position in accordance with conditions set by the market participant. In step 5a the market participant creates a conditional market order for opening a position according to the routine described in FIGS. 3 and 4. In step 5b new data on the constantly changing financial instrument parameter is received by the server system. In step 5c variables and arrays are initialized. In step 5d the system considers the new data point received. If the condition is not fulfilled one returns to step 5b. If the condition is fulfilled the order is sent 5f to the electronic broker and the new position is opened 5g.

The method described above thus performs or enables the following operations:
Displaying of information on a regularly changing variable or parameter in form of graphical elements
Selection of two or more graphical elements in response to a click action of a cursor or any other similar device
Selection of the condition and the type of action to be automatically executed by the system upon the fulfilment of the condition
Receipt of additional information and its identification as relating to the graphical elements
On the basis of new information, verification of the condition and its automatic execution

One skilled in the art would appreciate that the method according to the invention can be used in various environments different from the embodiment described herein. For example, it could be applied to a number of graphical instruments used in applied finance including, but not limited to the ones traditionally employed in standard technical analysis of futures and commodities markets. The method could also be applied in professions that imply the observation of constantly changing parameters such as the forecasting of natural processes.

In the following section we shall describe, with reference to examples, the method of processing and analysing market data and making a trading decision that may be implemented by means of the electronic trading system according to this invention. The ultimate purpose is to assist an analyst, investor or trader in making and implementing a buy, sell, hold and many other types of decisions and recommendations.

With reference to FIGS. 6a to 6e, an example of analysis, decision-making and decision implementation procedures performed by a hypothetical market participant using a trading system according to this invention will now be described to better illustrate features of the trading system. In this example, we shall consider a currency trader on the US Dollar/Swiss Franc market.

The goal of the market participant is to identify as unambiguously as possible the expected market direction as well as the expected correct moment for entering the market. To this end the market participant requests from the server system 10-minute frequency market quotes, provided for example by Reuters, for the three month period between Apr. 6, 2001 and Apr. 9, 2001. To request the quotes the user selects a “get quotes” command from the File menu in the charting window 20, and chooses the time period and the time step (frequency). The request is sent to the database 10 via the business server 14. The server site sends a response to the client site and the market participant's PC reproduces the response in the form of graphical elements plotted in the chart area 58 on his PC computer screen.

Referring to FIG. 6a, the real-time chart is then transformed into a trajectory T6a in Increment-Change Space with the normalisation step r=0.00286. To transform a standard real-time chart into a trajectory in Increment-Change Space the market participant clicks on the Duka transformation command button 60 from the command bar 56. The system automatically opens the “Set r parameter” box 76 shown in FIG. 6a offering the market participant to specify the normalization amplitude r (field 78). This can be done by one of the following: selecting the default value automatically calculated by the system as the average difference between the maximum and minimum values of the incoming quote values (amplitude r=1); selecting a value of r from a list offered by the system and calculated as the default value of r multiplied by a factor such as 0.5, 2, 3, etc; or entering the value of r directly in r manual entry field 80 using a computer keyboard or a similar device. A new window may be automatically created for the Increment-Change chart by selecting check-box 82. Once the parameters are selected the market participant validates his request with the “apply” button 84.

Referring to FIG. 6b, if the market participant chooses to plot support and resistance lines, he selects two points of the trajectory T6 in Increment-Change Space such as points P6b1 and P6b2 which in his view belong to the support and resistance lines and clicks on the “trend line up” button 64 from the command bar 56. The system activates the “Properties for Trend” dialog box 86 shown in FIG. 6b allowing to specify the value of the coefficient q in a q value entry field 88. The data processing system automatically displays the value of q_max—the highest value of the coefficient q obtained from the whole data array, as described in international application WO 01/195176. Alternatively the market participant can specify any different value of the q coefficient. In addition, by clicking on the “more” button 90 the market participant can specify the graphical representation properties of the support and resistance lines by using the line size field 92, line type field 94 and line colour field 96. Upon clicking the “apply” button 100 the request is sent to the database 10 via business server 14. The database performs and stores calculations and sends a response to the client site and the market participant's PC reproduces the response in the form of graphical elements, in this example, support and resistance lines S6c and R6c as shown in FIG. 6c, plotted in the chart area 58 on his PC computer screen.

Referring to FIG. 6c, if the market participant believes that the market has exited a period of horizontal drift in between points P6c1 and P6c2 and has entered a growth phase whose development is defined by support and resistance lines S6c and R6c, he may question is how long this upward trend is likely to last. The market participant can decide to enter the market when the trend is broken, thus betting on the downward movement of the quote, which in this case would mean buying the Swiss franc against the dollar.

To this end, the market participant selects the amount to be transacted (for example 10 lots of USD 10,000), the type of transaction (for example “down”) and chooses to create a “complex condition”. In order to specify precisely the condition under which the order is to be executed, the market participant selects with the cursor the financial instrument trajectory T6 which appears as “curve 2” in field 102 in FIG. 6c and then the support line S6c which appears as “curve 1” in field 104 and sets the condition by choosing the operator “>” (greater than) in field 106 such that the server system will automatically open a downward position as soon as the quote trajectory T6 crosses and moves below the support line (S6c>T6). The condition is validated by clicking on the “accept” button 108. Such automatic setting up of the system considerably facilitates the market participant's task of entering the market. This is the case because at the time the decision is made the trader has no information to be able to forecast at which point the support line S6c would be broken—in the absence of such information the market participant would need to perform a constant monitoring of the market evolution. Apart from the fact that such monitoring is clearly time consuming, it may also diverge trader's attention from other, possibly more profitable segments of the market.

To continue with the example of the US Dollar/Swiss Franc trader let us now consider the decision making and implementation process for the closing the down position considered earlier.

FIGS. 6d and 6e depict an Increment-Change space chart for the two month period 24 Aug. 1 until 23 Oct. 1, where an Increment-Change space trajectory T6e is plotted together with the smoothened trajectory C6e, support and resistance lines S6b1 and R6b1 from FIG. 6a, new support and resistance lines S6e2 and R6e2 and quantum lines Q6e drawn from point P6e1. To plot the quantum lines the user selects a point on the Increment-Change space trajectory from which the quantum lines are to be drawn and clicks on the quantum lines command button 68 from the command bar 56. The system activates the “Quantum line properties” dialog box 110 shown in FIG. 6d allowing the market participant to select the direction, in direction field 112—upward or downward—according to which the quantum lines are to be drawn, and the number of those quantum lines in checkboxes 114. Upon clicking the “apply” button, the request is sent to the database 10 via the business server 14. The database performs and stores calculations and sends a response to the client site and the market participant's PC reproduces the response in the form of graphical elements, in this example the quantum lines Q6e, plotted on his PC computer screen.

It may also be noted in this example that for FIGS. 6d and 6e only the navigation and trading position windows are shown. This illustrates the fact the choice of the type and number of windows displayed simultaneously on the screen device rests entirely with the preferences of the market participant.

From FIG. 6e we can see that the open down order would be executed by the system at point P6e2. Naturally the trader addresses the question whether the current position should be closed or perhaps reversed. The simplest decision would be to create a condition for closing the market position upon the intersection of the resistance line R6e2 by the trajectory T6e similar to the procedure described above. In this case our hypothetical trader would have achieved a profit approximately equal to 800 basis points. However, a closer look at the chart suggests that maximum unrealized profit, at point P6e3, is approximately 1130 basis points, which is approximately 40% higher. The difference corresponds to the upward-sloping section on the chart between points P6e3 and P6e5. Thus although profitable, the market participant's strategy was not optimal.

It may be advantageous to employ a variety of instruments in order to achieve an optimal decision. For example, an additional signal for the downward trend reversal in FIG. 6e can be provided by the quantum lines Q6e drawn from point P6e1. A more risk-averse trader could set up the market order such that the position is closed upon the intersection of the fourth quantum line, i.e. at point P6e4. In our example this is a better choice for the market participant since, as it has been shown, his profitability will increase considerably. However, this need not be the case in all circumstances since the exit would be premature if the market continued its downward movement. Therefore, there is a case for using several graphical elements simultaneously to optimize the analysis of the movement of the financial instrument. In practice, it is often preferable to use a combination of several conditions for entry and exit strategies. Examples of such strategies will be discussed below.

To optimize market participant's decision making the software allows combining several complex conditions using the “and”, “or, “then” operators to create orders for opening as well as closing a market position. As an illustration let us consider a trader on the Euro/US dollar working with the chart shown in FIGS. 7a to FIG. 7c. In order to keep the illustration lucid let us assume for the purpose of this example that in his analysis the trader employs three graphical elements: an Increment-Change space trajectory T7 normalized at step r=0.00069 and representing the EUR/USD movement, upward-sloping trend support and resistance lines S7 and R7, and a moving average curve C7. To plot the moving average curve the market participant selects with a mouse cursor or a similar device the Increment-Change space quote trajectory T7 and clicks on the moving average command button 70 from the command bar 56. The “properties for moving average bundle” dialog box 102 is activated (FIG. 7a) allowing the market participant to specify using field 118 or field 120 the value of the coefficient q to be used for plotting the moving average curves as well as their type and quantity. Upon clicking the Apply button 124 the request is sent to the database 10 via the business server 14. The database performs and stores calculations and sends a response to the client site and the market participant's PC reproduces the response in the form of graphical elements, in this case the moving average curve C7, plotted on his PC computer screen, as shown in FIG. 7b.

In FIG. 7b the moving average curve is plotted with quantum number n=2 with the life span of 43 points. Analyzing the trajectory T7 based on 1-minute real time input data, the trader is trying to identify the end of the upward trend which started from point P71. The end of this trend could be identified as taking place upon the crossover of the support line S7 by the trajectory T7 and the moving average curve C7, the two signals reinforcing each other. Within the framework of an electronic trading system according to this invention, the creation of such an order is relatively simple and can be achieved using the “and” operator 132. Thus, the market participant inputs into the system an order for opening a down position upon the intersection of the support line S7 by the financial investment trajectory T7 and the moving average curve C7. In practice this can be implemented in the following way. In the position input window 22 shown in FIG. 2, the market participant selects the trading direction, in this case “down”, in “up-down” field 30 and the trading volume in “lots” field 32, in this case “10” lots. In “open condition” field the market participant selects “complex condition”.

Referring to FIG. 7b, in the chart area 58 the market participant selects with a cursor two graphical elements (trajectory T7 and support line S7) and the condition, in this case operator “<”, i.e. T7 “less than” S7, and validates by pressing the “accept” button 108. Two or more pairs of graphical elements can be combined by using the command buttons “then” 128, uor” 130 or “and” 132. In this example the market participant uses the “and” command 132 and selects two further graphical elements (moving average curve C7 and the support line S7) and the condition “<”, i.e. C7 “less than” S7, and validates his order by pressing the “OK” button 134.

In the context of creating a market order through a complex condition it is advantageous to provide the market participant with a tool to track, verify and edit complex conditions created earlier. Upon the validation of a complex condition by the market participant, the client PC or server system stores the condition and upon request displays it in form of graphical or text symbols. With reference to FIG. 7c, a complex condition display field 138 displays two complex conditions 140 and 142 and the “and” operator 144 created according to the routine described above. By selecting one of the conditions 140 or 142 and clicking on “curve 1” button 146 or “curve 2” button 148 the relevant graphical element is highlighted in the charting window. In case the charting window that had been used for creating the complex condition was closed, the market participant can use the view command button 150 to request an automatic re-creation of that charting window.

It may be noted that the creation of a complex condition could be implemented in the same manner when creating an order for closing a position that is open now or will be opened in the future. We shall use the following example to illustrate the use of the “then” operator for combining several complex conditions. Referring to FIGS. 8a and 8b, a chart in Increment-Change space based on 1-minute real-time input Euro/US dollar data with the trajectory T8 normalized at increment step r=0.00047 is shown. Let us assume that a trader has an up position opened and is attempting to identify the optimal point at which the position should be closed. In this example we use a combination of the trend lines R8b, S8b and development equation curve D8b. To plot the development equation curve the market participant selects a point P8al on the Increment-Change space trajectory T8 from which the development equation curve is to be drawn and clicks on the development equation curve command button 72 from the command bar 56. The “properties for development trajectories” dialog box 152 is activated allowing the market participant to select in field 154 the direction —upward or downward—according to which the development equation curve is to be drawn and in fields 156 or 158 the value of the coefficient q, either chosen between the values calculated automatically by the system, such as the value of q=q_max or any other value of q specified by the market participant. Upon clicking the “apply” button 160 the request is sent to the server system database 10. The database performs and stores calculations and sends a response to the client site and the market participant's PC reproduces the response in the form of graphical elements (curve D8b) plotted on his PC computer screen.

The development equation curve D8b conventionally serves as the outer envelope for the quote trajectory T8b—when the latter “touches” the development curve one could for example assume that the trend has reached its maximum speed and will soon be reversed. Considering this assumption, the trader may set up the condition for closing the position upon the quote trajectory being more or equal the development equation curve followed by the intersection of the support line, which can be implemented by making use of the “then” operator. The benefits of specifying the condition in the following way are apparent from the diagram: a temporary crossover of the support line S8b in the area between points P8b1 and P8b2 shows how a condition based simply on the support line would lead to a premature closing of a profitable position. On the other hand, in the specification proposed above the trader is effectively taking advantage of the full length of the trend closing the position proximate at its peak.

The final point to be considered here is that within the framework of the electronic trading system, there exists another useful method of avoiding problems linked to “noisy” fluctuations leading to very temporary or intersections between various graphical elements such as at point P8b3. Upon the setting of the complex condition it is possible to fix a certain distance of the “quote shift” or “time shift” delay for opening or closing a position under a complex condition by entering a value in the quote shift field 162 respectively time shift field 164. By specifying a quote shift delay measured in basis points and which can be positive or negative the position will be opened or closed upon the fulfilment of the complex condition (for example an intersection of two curves) plus or minus a certain interval in basis points as measured by the quotes value on the vertical axis. Similarly a time delay will mean the execution of a graphical condition plus a distance measured in standard units of measurement of the horizontal axis.

Let us now turn to another example involving a trader active on the US Dollar/Japanese yen market. The hypothetical trader could for example be a “day trader”, defined as a market participant who typically holds a position for no more than two trading days, concludes several deals per day and his average trading profit or loss is relatively small, usually amounting to no more than 100 basis points. Since such trader would be mainly concerned with the short-term market fluctuations, his decision making has to be particularly fast. It is important for such trader to have available a trading system that would implement trading decisions in the most timely and efficient manner.

FIG. 9a displays a trajectory T9 in Increment-Change space at the normalization step r=0.11296 based on Reuters 1-minute quotes for USD/JPY. Let us assume that the trader is taking an operational trading decision at point P91. At this point the information available to the trader reveals that the quote trajectory T9 has reached its previous bottom as defined by the “last minimum” line L91. However, at the decision making point the trader has no clear-cut indication of whether this is a familiar “double bottom” structure often used in traditional technical analysis, which conventionally serves as an indicator for the reversal of the downward trend, or whether the downward trend will continue below the “last minimum” line. To plot last minimum or last maximum lines the market participant selects the Increment-Change trajectory T9 using the client PC cursor and clicks a last minimum-last maximum command button 74 from the command bar.

One solution could be to wait for the market to deliver more concrete directional signals and open a position at a later point in time. However, this could potentially erode a large share of the possible profit, which, as it has been noted, is already quite limited for the day trader.

Another solution could be to place two orders with the system, simulating the two possible scenarios (downward or upward movement) for the quote trajectory T9. To this end the trader can request the system to calculate the levels of the previous minimum values of the quote (inflection points) and plot the corresponding horizontal line (L91). In the trading window the market participant creates for example an order to open a down position upon the crossover of the “last minimum” line L91 by the trajectory T9. Upon its intersection the market participant may consider for example that the market is taking a downward direction.

At the same time, the trader may enter a market order in the opposite direction (FIG. 9b). For this purpose he can simultaneously employ two graphical elements: the downward-sloping resistance line R9 and support line S9 for the possible downward trend and the smoothened trajectory line C9. Using the cursor to select the graphical elements and the “or” operator button 130, the trader creates an order for opening an up position on USD/JPY in case the quote trajectory T9 crosses the resistance line R9 or the smoothed trajectory line C9. The two orders and the condition are displayed in the condition display field 136 as shown in FIG. 9b.

This simple example shows how, in the presence of uncertainty, a market participant can effectively create market orders for taking advantage of diverging scenarios for market behaviour. Of course there are many ways that the market participant's strategy defined by using several graphical elements, several “and”, “or”, “then” operators, time and quote delays etc. Similarly the market participant can set the close conditions based on the same graphical elements such that, for example the position will be closed in case of re-intersection by the quote trajectory of the smoothed curve and the resistance line or, possibly, upon the fulfilment of a condition based on new graphical elements.

In summary, the electronic trading system described hereinabove is an online system for graphical representation of financial information and trading of financial instruments such as foreign exchange, stocks, derivatives etc. The system provides a financial market participant (analyst, trader, investor) with a number of tools for visual representation and analysis of financial data as well as a trading system to be used for creating electronic trading orders for the purchase and sale of financial market instruments.

In practice, the success of a market participant depends on three main conditions: the correct identification of the current and future market direction (i.e. the trend), the moment in time and the price at which the participant should decide enter the market through buying and selling certain financial instruments, and, finally, the timely and efficient implementation (execution) of the participant's decision. The necessary fulfilment of the above conditions can be instrumental to the ultimate success or failure of financial operations. For example, in the context of constantly changing markets the benefits to be derived from a correct decision with regards to market direction can be eroded by entering the market at a sub-optimal price.

The electronic trading system according to this invention provides the market participant with a portfolio of analytical instruments to make and execute a trading decision. More specifically, the system allows the market participant to receive, process and depict incoming financial data (quotes) and represent it in form of charts. The system makes available tools for analysing the movement of financial instruments and making trading decisions or recommendations. These tools include:
a database of market data (quotes)
a data filtering method executable by a program module for transforming real market data into a trajectory in Increment-Change space
methods executable by program modules for calculating and drawing Increment-Change space analysis lines such as support and resistance lines, quantum lines, development equation line(s), beams, beam-average curves, the fastest trajectories, lines for previous minimums and maximums and variations thereof
a trading and portfolio management tool including a method executable by a program module for opening and closing market positions based on the on-screen selection of the above described analysis lines.

The trading system allows the market participant to create a number of trading portfolios. These portfolios can be used to purchase new securities, sell the securities purchased earlier, create and edit conditional purchase or sell orders, and so forth. Decisions can be based on one or several conditional criteria derived from the visual interpretation of incoming data with the help of analysis tools mentioned above.

1. A method of processing and displaying financial information on an electronic display of a market participant, comprising the steps of:
providing an electronic trading system comprising a server system accessible via a communications network by said market participant;
selecting and downloading from the server system data on a financial instrument;
generating and displaying graphical elements on said display, said graphical elements including a first graphical element being a graphical representation of a financial instrument and a graphical representation of an information analysis tool;
selecting at least said first and second graphical elements by means of a display pointing device; and
applying at least one of a plurality of conditions on said first graphical element with respect to said second graphical element enabling action to be taken automatically by said server system on said financial instrument when said condition is satisfied.

2. Method according to claim 1, wherein said condition is applied by selecting a list of conditions presented on said display by means of said display pointing device.

3. Method according to claim 1, wherein said information analysis tool is generated by the server system based on one or more points selected by the market participant on said display by means of said display pointing means.

4. Method according to claim 3, wherein said information analysis tool includes support and/or resistance lines.

5. Method according to claim 3, wherein said information analysis tool includes quantum lines.

6. Method according to claim 3, wherein said information analysis tool includes a development equation curve.

7. Method according to claim 1, wherein said plurality of conditions include operators “greater than” and “smaller than”.

8. Method according to claim 7, wherein said plurality of conditions include a quote shift and/or a time shift.

9. Method according to claim 1, comprising the further steps of applying a further condition of “and”, “or” or “then” and repeating the steps of claim 1 on at least two graphical elements that may be the same or different to said first and second graphical elements.

10. Method according to claim 1, wherein said financial instrument is represented graphically as a trajectory in Increment-Change space.

11. Method according to claim 1, wherein said financial data is received by said server system in real time from a financial information service provider.

12. An electronic trading system for assisting a market participant in trading in a financial instrument, comprising a server system for processing data on a financial instrument and software for generating and displaying an image including graphical elements on an electronic display, a first graphical element being a graphical representation of a financial instrument and a second graphical element being a graphical representation of a financial information analysis tool, said software adapted to enable selection of said first and second graphical elements by means of a display pointing device and to enable applying at least one of a plurality of conditions on said first graphical element with respect to said second graphical element such that an action is taken automatically by said server system on said financial instrument when said condition is satisfied.

13. Electronic trading system according to the preceding claim, wherein said electronic display is at a client site accessible via a communications network to a server site comprising said server system.

14. Electronic trading system according to claim 12, wherein said server system is connected to an electronic broker to send trading orders electronically from the electronic trading system to said electronic broker.

15. Electronic trading system according to claim 12, wherein said server system is electronically connected to a data source providing real time data on a financial instrument.

16. Electronic trading system according to claim 12, wherein said image generated by said software includes a charting window having a chart area in which the graphical elements are plotted, and a trading position input window enabling said market participant to create a trade order, said trading position input window comprising fields for defining the type of trade to be carried out on the financial instrument, and for selecting and applying said conditions which include operators “greater than” and “smaller than”.

17. Electronic trading system according to the preceding claim wherein said image further includes a navigator window for displaying a series of charts that have been created and opened by the market participant, each chart being selectable by means of said display pointing device for display in the charting window.

18. Electronic trading system according to claim 16, wherein said image further includes a quote window for displaying various financial instruments that may be selected by means of said display pointing device for display in the charting window.

19. Method of processing and displaying financial information on an electronic display of a market participant and automatization of a trading decision, comprising the steps of:
providing an electronic trading system comprising a source of market data;
selecting and downloading from the said source data on a financial instrument;
generating and displaying graphical elements on said electronic display;
selecting a pair of said graphical elements by means of a display pointing device and application for their comparison of any of the comparison conditions “smaller than”, “greater than”, smaller than or equal”, or “greater than or equal” enabling an action predefined by said market participant to be taken by said system when said comparison condition is satisfied.

20. Method according to claim 19, wherein the application of the comparison condition is carried out by selection thereof with a display pointing device, from a menu containing graphical or text symbols identifying the comparison conditions.

21. Method according to claim 19, wherein in order to enable a predefined action by the system, two or more said pairs of graphical elements are used.

22. Method according to claim 21, wherein the processing order of said analyzed pairs of graphical elements by the system is carried out by applying one or several of the logical conditions “and”, “or”, or “then”.

23. Method according to claim 22, wherein the application of the said logical conditions is carried out by selection thereof with a display pointing device, from a menu containing graphical or text symbols identifying the logical conditions.

24. Method according to claim 19, wherein the procedure created by the market participant for taking a predefined action is automatically recorded and stored by the trading system.

25. Method according to claim 24, wherein the said procedure is recorded in the form of a set of graphical or text symbols of said pair or pairs of graphical elements as well as comparison and logical conditions.

26. Method according to claim 24, wherein the trading system provides the market participant with the possibility to verify said procedure through selection of said text or graphical symbol of a graphical element by means of a display pointing device whereby the system displays the chart where said graphical element is plotted and highlighted.
